(19) United States
(12) Patent Application Publication
(10) Pub. No.: US 2020/0314301 A1
(43) Pub. Date: Oct. 1, 2020

(54) LENS MODULE

(71) Applicant: HON HAI PRECISION INDUSTRY CO., LTD., New Taipei (TW)

(72) Inventors: YA-LAN FENG, New Taipei (TW); CHUN-CHENG KO, New Taipei (TW)

(21) Appl. No.: 16/743,515

(22) Filed: Jan. 15, 2020

(30) Foreign Application Priority Data
Mar. 29, 2019 (CN) 201910248381.8

(51) Int. Cl. H04N 5/225; G02B 7/02; G02B 7/10

(52) U.S. Cl. CPC H04N 5/2254; G02B 7/10; G02B 7/021

(57) ABSTRACT

A lens module includes a lens barrel and a number of lenses mounted in the lens barrel. The lens barrel includes a peripheral wall and a top wall. The top wall includes a light transmission hole. The top wall further includes a light shielding portion surrounding an opening of the light transmission hole. A distal end of the light shielding portion extends toward the plurality of lenses and blocks light.

### FIELD

The subject matter herein generally relates to lens modules, and more specifically to a lens module having an improved imaging function.

### BACKGROUND

More and more electronic devices come equipped with lens modules for imaging functions. However, when a lens module captures an image, light at a specific angle may enter an inner wall of a lens barrel of the lens module, and the light will be reflected and refracted by the lens barrel to an image sensor, which increases glare in the captured image.

### BRIEF DESCRIPTION OF THE DRAWINGS

Implementations of the present disclosure will now be described, by way of embodiments, with reference to the attached figures.

FIG. 1 is an assembled, isometric view of an embodiment of a lens module.

FIG. 2 is an exploded, isometric view of the lens module in FIG. 1.

FIG. 3 is similar to FIG. 2, but showing the lens module from another angle.

FIG. 4 is a cross-sectional view taken along line IV-IV in FIG. 1.

FIG. 5A shows a photo taken by a lens module in the related art.

FIG. 5B shows a photo taken by the lens module in the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

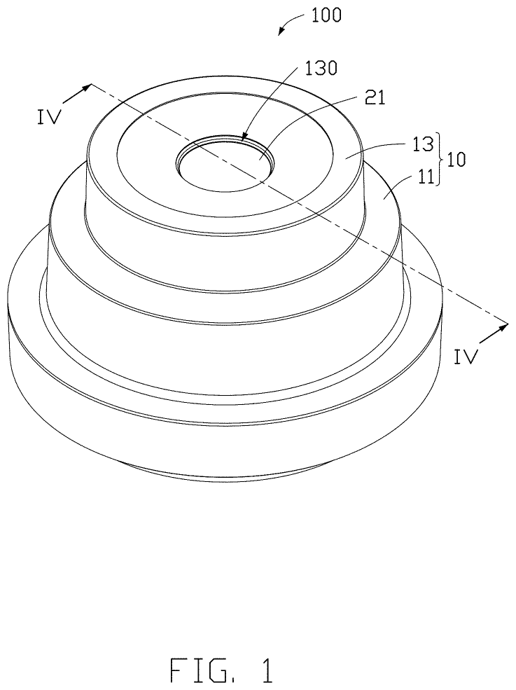

FIG. 1 shows an embodiment of a lens module 100 applicable in an electronic device, such as a mobile phone, a tablet computer, a notebook computer, or the like.

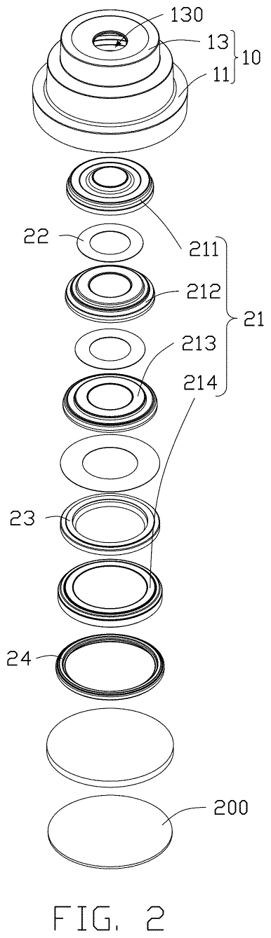

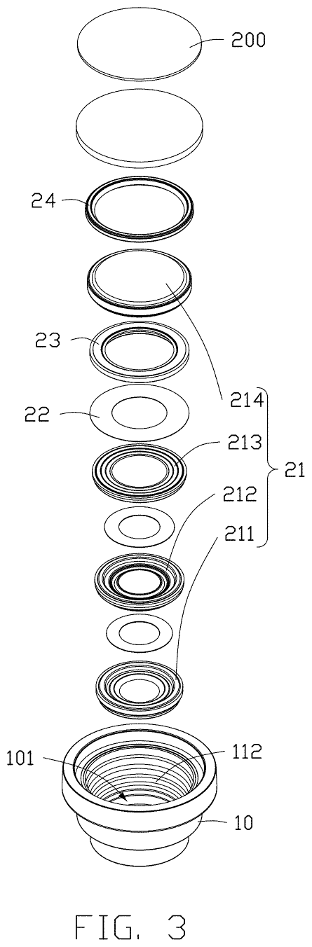

Referring to FIGS. 1-3, the lens module 100 includes a lens barrel 10, a plurality of lenses 21, a soma 22, a spacer 23, and a retainer 24. The plurality of lenses 21, the soma 22, the spacer 23, and the retainer 24 are mounted in the lens barrel 10.

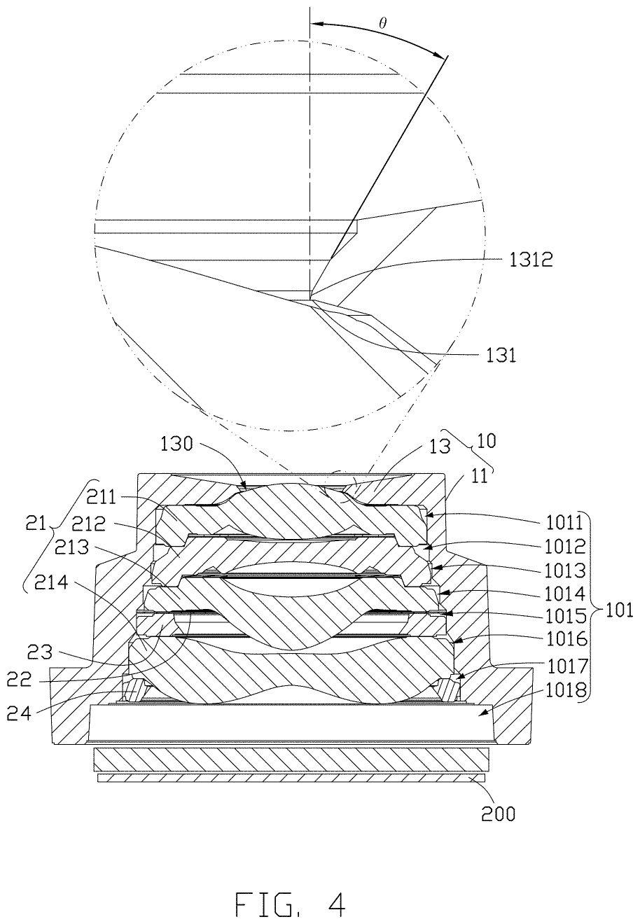

Referring to FIG. 4, the lens barrel 10 includes a peripheral wall 11 and a top wall 13, wherein the top wall 13 is located at one end of the peripheral wall 11. A receiving cavity 101 is cooperatively formed by the peripheral wall 11 and the top wall 13 to receive the plurality of lenses 21, a plurality of somas 22, the spacer 23, and the retainer 24.

An end of the peripheral wall 11 opposite the top wall 13 is fixed on a circuit board (not shown) in the electronic device. The top wall 13 is located outside the electronic device.

A light transmission hole 130 is formed in a middle of the top wall 13. The light transmission hole 130 communicates with the receiving cavity 101 to transmit external light therethrough. The top wall 13 includes a light shielding portion 131. The light shielding portion 131 surrounds an opening of the light transmission hole 130. A distal end of the light shielding portion 131 extends toward the plurality of lenses 21. The light shielding portion 131 is configured to block light from entering the receiving cavity 101 between the top wall 13 and the plurality of lenses 21.

The light shielding portion 131 includes a sidewall 1312. The sidewall 1312 is located on a side of the light shielding portion 131 facing away from the peripheral wall 11. The sidewall 1312 is gradually closer to an optical axis of the plurality of lenses 21 in a direction toward the plurality of lenses 21. The sidewall 1312 has an included angle θ with the optical axis. The included angle θ ranges from 15° to 30°. In one embodiment, the included angle θ is 25°.

It can be understood that in other embodiments, the sidewall 1312 may be curved, and a value of the included angle θ ranges from a tangent line at a distal end of the sidewall 1312 to the optical axis.

It can be understood that in other embodiments, the included angle θ may be any value, as long as the light shielding portion 131 blocks light.

A plurality of annular protrusions 112 is provided on an inner side of the peripheral wall 11. Along a direction toward the top wall 13, the plurality of annular protrusions 112 protrudes closer toward a center of the lens barrel 10. The receiving cavity 101 is surrounded by the plurality of annular protrusions 112 to form a first cavity 1011, a second cavity 1012, a third cavity 1013, a fourth cavity 1014, a fifth cavity 1015, a sixth cavity 1016, a seventh cavity 1017, and an eighth cavity 1018. The first cavity 1011, the second cavity 1012, the third cavity 1013, the fourth cavity 1014, the fifth cavity 1015, the sixth cavity 1016, the seventh cavity 1017, and the eighth cavity 1018 are coaxial and sequentially gradually increase in diameter. The first cavity 1011 is located adjacent to the top wall 13.

The plurality of lenses 21 includes a first lens 211, a second lens 212, a third lens 213, and a fourth lens 214. The first lens 211, the second lens 212, the third lens 213, and the fourth lens 214 sequentially gradually increase in diameter. The first lens 211, the second lens 212, the third lens 213, and the fourth lens 214 are sequentially stacked and housed in the receiving cavity 101.

The first lens 211 is received in the first cavity 1011. An outer side of the second lens 212 is received in the third cavity 1013, and a middle portion of the second lens 212 protrudes into the second cavity 1012. An outer side of the third lens 213 is received in the fourth cavity 1014, and a middle portion of the third lens 213 is recessed into the fifth cavity 1015. The fourth lens 214 is received in the sixth cavity 1016, and a portion of the fourth lens 214 is recessed into the seventh cavity 1017.

The spacer 23 is received in the fifth cavity 1015, and two sides of the spacer 23 respectively support edge portions of the third lens 213 and the fourth lens 214. The retainer 24 is received in the seventh cavity 1017 and is used for supporting the fourth lens 214.

It can be understood that in other embodiments, a plurality of the spacers 23 may be used to support multiple lenses.

The plurality of somas 22 are respectively located between the first lens 211 and the second lens 212, the second lens 212 and the third lens 213, and the third lens 213 and the spacer 23. The plurality of somas 22 are respectively used to block light from exiting from an edge of the plurality of lenses 21.

It can be understood that in other embodiments, the number of the somas 22 is at least one.

An image sensor 200 and other components (such as a filter, not shown) are housed in the eighth cavity 1018.

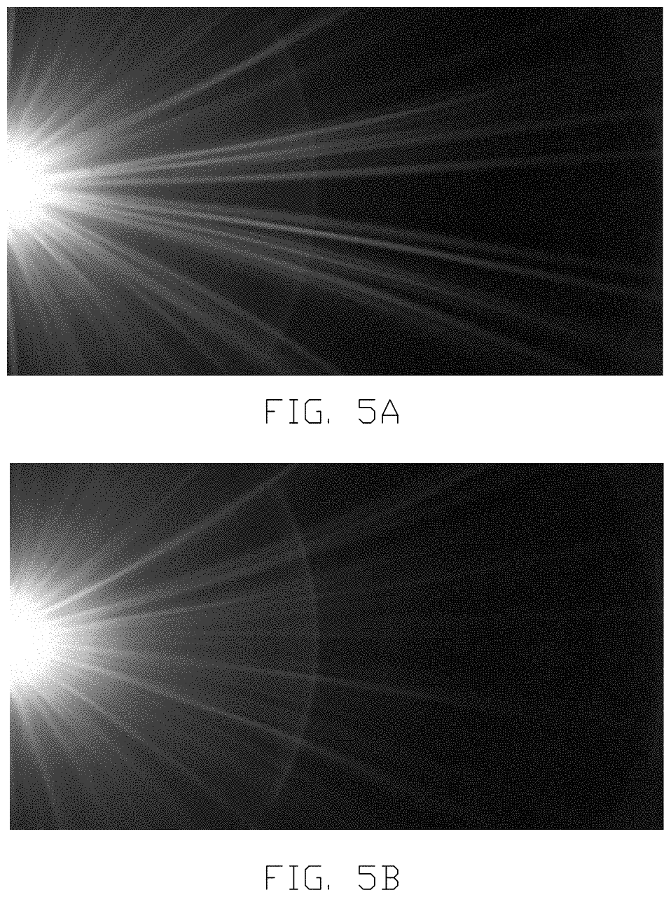

FIG. 5A and FIG. 5B show a photo taken by a lens module in the related art and a photo taken by the lens module 100, respectively. By comparing FIG. 5A and FIG. 5B, it can be seen that the lens module 100 can reduce glare by providing the light shielding portion 131 to block light from entering the receiving cavity 101 between the top wall 13 and the plurality of lenses 21.

Since the light shielding portion 131 needs to avoid interference with the plurality of lenses 21 while blocking light, an end of the light shielding portion 131 is relatively sharp. By providing the sidewall 1312 on the side of the light shielding portion 131 facing away from the peripheral wall 11, the light shielding portion 131 is made easier to process and produce by injection molding. Limiting the range of the included angle θ from 15° to 30° can make the ends of the light shielding portion 131 sharper to improve the light-shielding effect without increasing the difficulty of injection molding.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A lens module comprising:
a lens barrel comprising a peripheral wall and a top wall, the top wall comprising a light transmission hole; and
a plurality of lenses mounted in the lens barrel; wherein:
the top wall further comprises a light shielding portion surrounding an opening of the light transmission hole; and
a distal end of the light shielding portion extends toward the plurality of lenses.

2. The lens module of claim 1, wherein:
the light shielding portion comprises a sidewall located on a side of the light shielding portion facing away from the peripheral wall; and
the sidewall is gradually closer to an optical axis of the plurality of lenses along a direction toward the plurality of lenses.

3. The lens module of claim 2, wherein:
the sidewall comprises an included angle with the optical axis.

4. The lens module of claim 3, wherein:
the included angle ranges from 15° to 30°.

5. The lens module of claim 3, wherein:
the included angle is 25°.

6. The lens module of claim 2, wherein:
a value of the included angle ranges from a tangent line at a distal end of the sidewall to the optical axis.

7. The lens module of claim 1, wherein:
the lens barrel comprises a receiving cavity;
the plurality of lenses comprises a first lens, a second lens, a third lens, and a fourth lens;
the first lens, the second lens, the third lens, and the fourth lens sequentially gradually increase in diameter; and
the first lens, the second lens, the third lens, and the fourth lens are sequentially stacked and housed in the receiving cavity.

8. The lens module of claim 1, further comprising at least one spacer, wherein:
the at least one spacer is located between at least two lenses of the plurality of lenses to maintain a preset distance between the at least two lenses of the plurality of lenses.

9. The lens module of claim 1, further comprising at least one soma, wherein:
the at least one soma is located between at least two lenses of the plurality of lenses to block light from exiting from an edge of the at least two lenses of the plurality of lenses.

10. The lens module of claim 7, wherein:
a plurality of annular protrusions is provided on an inner side of the peripheral wall;
along a direction toward the top wall, the plurality of annular protrusions protrudes closer toward a center of the lens barrel;
the receiving cavity is surrounded by the plurality of annular protrusions to form a first cavity, a second cavity, a third cavity, a fourth cavity, a fifth cavity, a sixth cavity, a seventh cavity, and an eighth cavity;
the first cavity, the second cavity, the third cavity, the fourth cavity, the fifth cavity, the sixth cavity, the seventh cavity, and the eighth cavity are coaxial and sequentially gradually increase in diameter; and
the first cavity is located adjacent to the top wall.

11. The lens module of claim 10, wherein:
the first lens is received in the first cavity;
an outer side of the second lens is received in the third cavity, and a middle portion of the second lens protrudes into the second cavity;
an outer side of the third lens is received in the fourth cavity, and a middle portion of the third lens is recessed into the fifth cavity; and
the fourth lens is received in the sixth cavity, and a portion of the fourth lens is recessed into the seventh cavity.

12. The lens module of claim 11, wherein:
a spacer is received in the fifth cavity, and two sides of the spacer respectively support edge portions of the third lens and the fourth lens; and
a retainer is received in the seventh cavity and is used for supporting the fourth lens.

13. The lens module of claim 12, further comprising an image sensor, wherein:
the image sensor is housed in the eighth cavity.
